(19) United States
(12) Patent Application Publication
(10) Pub. No.: US 2016/0246940 A1
(43) Pub. Date: Aug. 25, 2016

(54) METHOD AND SYSTEM FOR RECOMMENDING ANALOGOUS PAIN TREATMENT UTILIZING BIOMEDICAL TECHNOLOGY

(71) Applicants: LAKSHYA JAIN, LOS ALTOS, CA (US); PRIYA BISARYA, SAN DIEGO, CA (US)

(72) Inventors: LAKSHYA JAIN, LOS ALTOS, CA (US); PRIYA BISARYA, SAN DIEGO, CA (US)

(21) Appl. No.: 14/625,638

(22) Filed: Feb. 19, 2015

(51) Int. Cl. G06F 19/00

(52) U.S. Cl. CPC G06F 19/3456; G06F 19/322; G06F 19/345

(57) ABSTRACT

The present disclosure provides a method and system for recommending an analogous treatment for one or more users. The method and system includes assessing intensity of pain experienced by each of the one or more users, generating a pain profile for each of the one or more users, mapping the one or more users with other one or more users having identical pain profiles and attributes from a plurality of attributes, creating one or more treatment profiles for each of the one or more users, producing one or more side effects profile for each of the one or more users and recommending an analogous treatment to each of the one or more users. The intensity of pain is assessed on a pre-determined set of pain monitoring scales based on age of the one or more users.

### TECHNICAL FIELD

The present invention relates to the field of biomedical technology and, in particular, relates to recommending analogous pain treatment utilizing biomedical technology accordingly.

### BACKGROUND

Pain is a highly complex and multidimensional phenomenon that energizes an organism, regardless of real or apparent tissue damage, to take an action in relieving and alleviating its presence. The pain is an unpleasant feeling caused by intense or damaging stimuli such as stubbing a toe, burning a finger, putting alcohol on a cut and the like. One can consider the pain to be a stressor and environment challenge that requires the organism to respond. It may be categorized according to various factors including type of damage, time for healing and the like. On the basis of the time for healing, some may classify the pain can be categorized as a chronic pain and an acute pain. The acute pain shows a sudden and sharp onset, whereas in the chronic pain, the sensation of pain remains for a long period even after the injury has healed. However, both the chronic pain and the acute pain are extremely important problems leading to loss of working capabilities, financial resources and the like.

The other classifications of the pain include nociceptive pain and neuropathic pain. For example, the nociceptive pain is a discomfort experienced as a result of an injury. The injury may include but not be limited to a paper cut, a broken bone, appendicitis and the like. The neuropathic pain is associated with an injury to a nerve or central nervous system. Such injuries can give rise to paresthesia. For example, the paresthesia may include but not be limited to numbness, tingling, “pins & needles” sensation, electrical sensations and the like.

Pain is the most common reason for physician consultation in most parts of the world. It is a major symptom in many medical conditions and can significantly interfere with a person's quality of life and general day-to-day functioning. The intensity of pain experienced by individuals is modulated according to psychological factors (for example, mood, attention, distraction and the like), biological factors (for example, sex, genetics and the like) and social factors (for example, marital status, social support and the like). Thus, the experience of pain depends on inter-individual variability. Therefore, pain management is an extremely important issue. Pain management requires approaches to measure and map pain. An effective pain management system can be an important contribution to manage and avoid the pain experienced by the individuals.

Presently, it is known that functional interactions exist between systems controlling cardiovascular functions and systems modulating perception of the pain. In addition, there are relationships between pain stimuli and autonomic reactions. Some changes happen in body due to reaction of autonomic nervous system (hereinafter ‘ANS’) to the pain. For example, blood pressure (hereinafter ‘BP’), heart rate (hereinafter ‘HR’), heart rate variability (hereinafter ‘HRV’) and the like. These interactions are important for diagnosing and regulating the pain. For example, the HRV can be used as an important indicator of the ANS reactivity to nociceptive stimulation. Some changes happen due to response of somatic nervous system to the pain which may include fidgeting or moving some limb of the body or any other type of physical movement under the pain. However, presently, there is no method and system that studies these relationships and the interactions to guide appropriate treatment, care, lifestyle and the like for healthy response in the individuals with respect to various forms of pain whether nociceptive, or neuropathic. Additionally, there is no method and system to effectively monitor the intensity of the pain experienced by the individuals. Furthermore, there is no method and system that helps the physician to treat the individuals based on prior references with the pain.

In light of the above stated discussion, there is a need for a method and system that overcomes the above stated disadvantages.

### SUMMARY

In an aspect of the present disclosure, a computer-implemented method including assessing, with a processor, an intensity of pain experienced by each of one or more users; generating, with the processor, a pain profile for each of the one or more users; mapping, with the processor, the one or more users with other one or more users having identical pain profiles and attributes from a plurality of attributes; creating, with the processor, one or more treatment profiles for each of the one or more users; producing, with the processor, one or more side effects profile for each of the one or more users and recommending, with the processor, an analogous treatment for each of the one or more users based on the one or more side effects profile of each of the one or more users. The intensity of pain is assessed on a pre-determined set of pain monitoring scales based on age of the one or more users. The generated pain profile shows the intensity of pain experienced by each of the one or more users at various points in body aiding in better medical treatment of each of the one or more users. The creation of the one or more treatment profiles includes categorizing the one or more users into groups of one or more users corresponding to pain response of each of the one or more users and sub-categorizing each of the categorized groups of the one or more users into one or more subgroups of one or more users based on a set of pre-determined attributes associated with the one or more users. The one or more treatment profiles are created for each of the one or more subgroups of the one or more users. The one or more side effects profile includes one or more side effects corresponding to one or more treatments provided to each of the one or more users and the one or more treatments are provided based on the set of pre-determined attributes associated with the one or more users. The analogous treatment is provided corresponding to the set of pre-determined attributes associated with the one or more users.

In an embodiment of the present disclosure, the computer-implemented method further includes generating one or more gain profiles for each of the one or more users. In another embodiment of the present disclosure, the one or more gain profiles depict rate of reduction of pain corresponding to each of the one or more users.

In an embodiment of the present disclosure, the set of pre-determined attributes includes at least one of state of mind of the one or more users and type of personality of the one or more users.

In an embodiment of the present disclosure, the recommendation of the analogous treatment is further based on medical history of the one or more users. The medical history of the one or more users corresponds to pre-existing medical condition of the one or more users, one or more previous treatments provided to the one or more users and one or more previous side effects experienced by the one or more users.

In an embodiment of the present disclosure, the one or more subgroups of the one or more users are provided with one or more treatment options based on a list of tolerable side effects provided by the one or more users.

In an embodiment of the present disclosure, the computer-implemented method further includes tabulating data of the pain response of each of the one or more users. The tabulated data is used for medical treatment of each of the one or more users.

In an embodiment of the present disclosure, the one or more side effects corresponding to the one or more treatments include various physical or mental ailments. The physical or mental ailments includes at least one of headache, swelling, weight gain, hair loss, drowsiness, anxiety, skin-disorders, neurological effect, cardiac effect, pulmonary effect, musculoskeletal effect, endocrinological effect, agitation, fatigue, muscle pain, joint pain, nausea, ulcers, sleeping problems, shortness of breath, memory problems, mood swings, loss of appetite, itching, rashes, internal bleeding, stomach pain, disturbance in blood flow, amnesia, loss of sight, hallucinations, asthma, dry mouth, convulsions, fast or irregular heartbeat, shivering, decrease in vision, indigestion, constipation, coughing, bleeding gums, sore throat, palpitations, anemia and depression.

In an embodiment of the present disclosure, the computer-implemented method is configured to store the generated pain profile of each of the one or more users, the one or more treatment profiles of each of the one or more users, the one or more side effects profile of each of the one or more users, the one or more gain profiles of each of the one or more users and the tabulated data of the pain response of each of the one or more users.

In another aspect of the present disclosure, a computer system is provided. The computer system includes a non-transitory computer readable medium storing a computer readable program; the computer readable program when executed on a computer causes the computer to perform steps. The steps include assessing an intensity of pain experienced by each of one or more users, generating a pain profile for each of the one or more users, mapping the one or more users with other one or more users having identical pain profiles, creating one or more treatment profiles for each of the one or more users, producing one or more side effects profile for each of the one or more users and recommending an analogous treatment for the one or more users based on the one or more side effects profile of each of the one or more users. The intensity of pain is assessed on a pre-determined set of pain monitoring scales based on age of the one or more users. The generated pain profile shows the intensity of pain experienced by each of the one or more users at various points in body aiding in better medical treatment of each of the one or more users. The creation of the one or more treatment profiles includes categorizing the one or more users into groups of one or more users corresponding to pain response of each of the one or more users and sub-categorizing each of the categorized groups of the one or more users into one or more subgroups of one or more users based on a set of pre-determined attributes associated with the one or more users. The one or more treatment profiles are created for each of the one or more subgroups of the one or more users. The one or more side effects profile includes one or more side effects corresponding to one or more treatments provided to each of the one or more users. The analogous treatment is provided corresponding to the set of pre-determined attributes associated with the one or more users.

In an embodiment of the present disclosure, the computer readable program when executed on the computer causes the computer to perform a further step of generating one or more gain profiles for each of the one or more users.

In yet another aspect of the present disclosure, a system includes a communication device. The communication device further includes a pain monitoring application to monitor an intensity of pain experienced by each of one or more users. The pain monitoring application includes an input/output module in a processor, the input/output module is configured to receive the plurality of one or more bio-markers associated with each of the one or more users; a display module in the processor, the display module is configured to display the plurality of one or more bio-markers associated with the one or more users; a diagnostic engine in the processor, the diagnostic engine is configured to assess the intensity of pain experienced by each of the one or more users; a presentation module in the processor, the presentation module is configured to generate a pain profile for each of the one or more users; a mapping module in the processor, the mapping module is configured to map and index the one or more users with other one or more users having identical pain profiles and attributes from a plurality of attributes; a generating module in the processor, the generating module is configured to create one or more treatment profiles for each of the one or more users; an output engine in the processor, the output engine is configured for producing one or more side effects profile for each of the one or more users; a recommendation engine in the processor, the recommendation engine is configured for recommending an analogous treatment for the one or more users based on the one or more side effects profile of each of the one or more users and a database in the processor, the database is configured to store the generated pain profile of each of the one or more users, the one or more treatment profiles of each of the one or more users, the side effects profile of each of the one or more users and the set of pre-determined attributes of the one or more users. The intensity of pain is assessed on a pre-determined set of pain monitoring scales based on age of the one or more users. The generated pain profile shows the intensity of pain experienced by each of the one or more users at various points in body aiding in better medical treatment of each of the one or more users. The creation of the one or more treatment profiles includes categorizing the one or more users into groups of one or more users corresponding to pain response of each of the one or more users and sub-categorizing each of the categorized groups of the one or more users into one or more subgroups of one or more users based on the set of pre-determined attributes associated with the one or more users. The one or more treatment profiles are created for each of the one or more subgroups of the one or more users. The one or more side effects profile includes one or more side effects corresponding to one or more treatments provided to each of the one or more users. The analogous treatment is provided corresponding to the set of pre-determined attributes associated with the one or more users.

In an embodiment of the present disclosure, the system further includes an application server configured to run the pain monitoring application. In another embodiment of the present disclosure, the system further includes a diagnostic engine configured to tabulate data of the pain response of each of the one or more users. The tabulated data is used for the medical treatment of each of the one or more users. In yet another embodiment of the present disclosure, the system further includes generating one or more gain profiles for each of the one or more users. The one or more generated gain profiles of each of the one or more users are stored in the database. In yet another embodiment of the present disclosure, the one or more gain profiles depict rate of reduction of pain corresponding to each of the one or more users.

In an embodiment of the present disclosure, the set of pre-determined attributes includes at least one of state of mind of the one or more users and type of personality of the one or more users.

In an embodiment of the present disclosure, the recommendation engine in the processor further recommends the analogous treatment based on medical history of the one or more users. The medical history of the one or more users corresponds to pre-existing medical conditions of the one or more users, previous treatments provided to the one or more users and one or more previous side effects experienced by the one or more users.

In an embodiment of the present disclosure, the one or more subgroups of the one or more users are provided with one or more treatment options based on a list of tolerable side effects provided by the one or more users.

In an embodiment of the present disclosure, the one or more side effects corresponding to the one or more treatments include various physical or mental ailments. The physical or mental ailments includes at least one of headache, swelling, weight gain, hair loss, drowsiness, anxiety, skin-disorders, neurological and/or cardio-pulmonary effects, agitation, fatigue, muscle pain, mood swings, loss of appetite itching, rashes, internal bleeding, stomach pain, disturbance in blood flow, amnesia, loss of sight, hallucinations, asthma, dry mouth, convulsions, fast or irregular heartbeat, shivering, decrease in vision, indigestion, constipation, coughing, bleeding gums, sore throat, palpitations, anemia and depression.

### BRIEF DESCRIPTION OF THE FIGURES

Having thus described the invention in general terms, reference will now be made to the accompanying drawings, which are not necessarily drawn to scale, and wherein:

FIG. 1 illustrates a system for recommending an analogous treatment for one or more users, in accordance with various embodiments of the present disclosure;

FIG. 2 illustrates a block diagram of a communication device, in accordance with various embodiments of the present disclosure; and

FIG. 3 illustrates a flowchart for recommending the analogous treatment for the one or more users, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

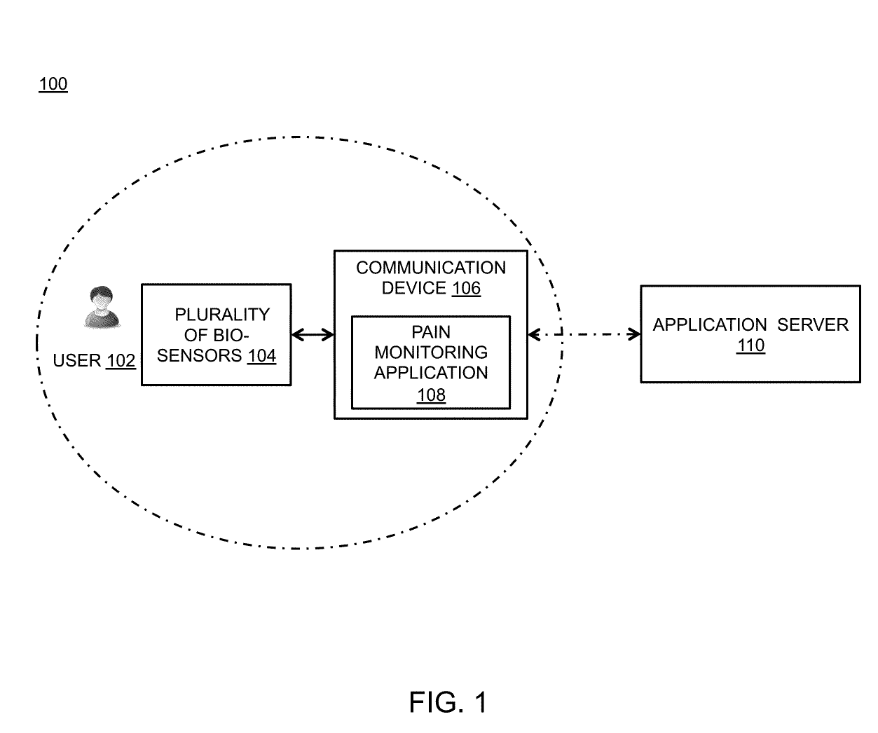

FIG. 1 illustrates a system 100 for recommending an analogous treatment for one or more users, in accordance with various embodiments of the present disclosure. The system 100 includes a plurality of bio-sensors 104 and a communication device 106 associated with a user 102. Examples of the communication device 106 include but may not be limited to mobile phone, laptop and desktop computer. The communication device 106 executes a pain monitoring application 108. The pain monitoring application 108 monitors the pain of the user 102 and allows tailoring of treatments accordingly. The pain monitoring application 108 communicates with an application server 110 via a network. The application server 110 runs the pain monitoring application 108. The user 102 may be a healthy individual or a patient suffering from the pain. The plurality of bio-sensors 104 fetches a plurality of one or more bio-markers associated with the user 102. The plurality of bio-sensors 104 include but may not be limited to a finger based pulse oximeter, an accelerometer, a respiration monitor and a 1-lead disposable electrocardiography (ECG) patch. The plurality of one or more bio-markers includes heart rate (hereinafter ‘HR’), blood pressure (hereinafter ‘BP’), respiratory information, skin conductance, Photoplethysmography (hereinafter ‘PPG’), oxygen saturation, electrocardiography (hereinafter ‘ECG’), electroencephalography (hereinafter ‘EEG’), muscle activity (hereinafter ‘EMG’), restlessness and the like.

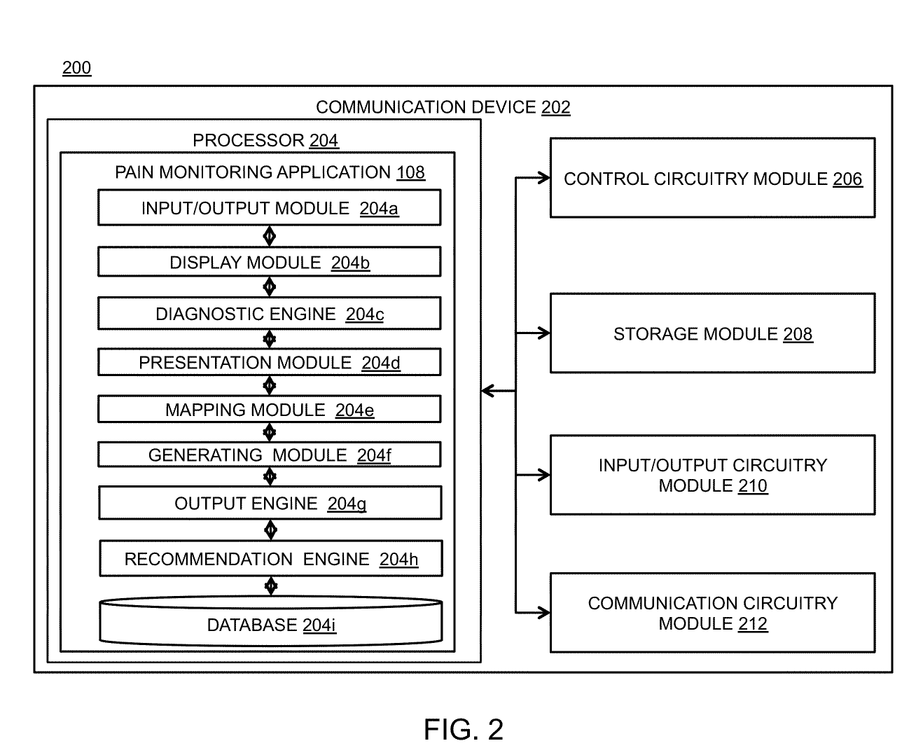

FIG. 2 illustrates a system 200 showing a block diagram of the communication device 202, in accordance with various embodiments of the present disclosure. It may be noted that to explain the system elements of the FIG.2, references will be made to the system elements of FIG. 1. The communication device 202 includes a processor 204, a control circuitry module 206, a storage module 208, an input/output circuitry module 210 and a communication circuitry module 212. Further, the processer 204 includes an input/output module 204a, a display module 204b, a diagnostic engine 204c, a presentation module 204d, a mapping module 204e, a generating module 204f, an output engine 204g, a recommendation engine 204h and a database 204i. The above stated components of the processor 204 enable the working of the pain monitoring application 108 for analyzing the intensity and area of the pain and model the pain to enable the tailoring of the treatments accordingly. The input/output module 204a receives the plurality of one or more bio-markers associated with the user 102. The display module 204b displays the received plurality of the one or more bio-markers associated with the user 102.

The diagnostic engine 204c assesses the intensity of the pain experienced by the user 102 of the one or more users. In addition, the intensity of the pain is assessed on a pre-determined set of pain monitoring scales based on age of the user 102. In an embodiment of the present disclosure, the intensity of the pain is assessed on a first type of pain monitoring scales of the pre-determined set of pain monitoring scales if the user 102 belongs to a category of adult patients. The first type of pain monitoring scales include but may not be limited to a Visual Analog Scale (VAS), a Verbal Numeric Rating Scale (VNRS), a Brief Pain inventory (BPI) and a Visual Descriptive System (VDS).

In another embodiment of the present disclosure, the intensity of the pain is assessed on a second type of pain monitoring scales of the pre-determined set of pain monitoring scales if the user 102 belongs to a to a category of pediatric patients. The second type of pain monitoring scales include faces pain scale, a face, legs, activity, crying and consolability (FLACC) scale, premature infant pain profile (PIPP), a wong baker scale, a pain assessment tool (PAT) and the like, which includes any other pediatric pain scale.

The presentation module 204d generates a pain profile of the user 102. The generated pain profile shows the intensity of the pain at various points in body of the user 102 aiding in better medical treatment of the user 102. Moreover, the pain profile is generated by utilizing color codes with respect to the location and the intensity of the pain experienced by the user 102. A change in intensity of the colors is directly proportional to the pain experienced by the user 102. Further, the diagnostic engine 204c tabulates data of pain response of the user 102. The tabulated data can help the physician to treat the user 102. Moreover, the display module 204b also displays the generated pain profile of each of the user 102.

The mapping module 204e maps the user 102 with other one or more users having identical pain profiles and attributes from a plurality of attributes. In fact, the mapping module 204e indexes the one or more users having the identical pain profiles and attributes from the plurality of attributes. The plurality of attributes includes but may not be limited to age, gender, pain area, weight and height. The database 204i stores the fetched plurality of one or more bio-markers associated with the user 102. In addition, the database 204i stores the generated pain profile of the user 102 and the tabulated data of the pain response of the user 102.

Further, the diagnostic engine 204c analyzes the mapped data of the user 102. The analyzed data can be used for the treatment of each of the one or more users having the identical pain profiles and attributes from the plurality of attributes. For example, a user X is found to have a left ankle injury and the database 204i reveals that a user Y having the same age and gender was also diagnosed and treated with the left ankle injury few months back. Then, the prescribed treatment for the user Y can be recommended for treating the user X as well. The database 204i also stores the analyzed data of the one or more users. In various embodiments of the present disclosure, these recommendations may be utilized by medical practitioners, pharmacist, medical supervisor and the like.

It may be noted that the diagnostic engine 204c tabulates data of the pain response corresponding to one or more users. Further, the system 100 categorizes the one or more users based on their phenotypical characteristics, genotypic characteristics, mental attributes and the like.

The generating module 204f generates one or more treatment profiles for each of the one or more users. Further, the generating module 204f generates the one or more treatment profiles by firstly categorizing the one or more users into one or more groups of one or more users. Each of the groups of one or more users corresponds to a different pain response. Moreover, the generating module 204f sub-categorizes each of the categorized groups of one or more users into one or more subgroups of one or more users based on a set of pre-determined attributes associated with the one or more users. The set of pre-determined attributes include but may not be limited to state of mind of the one or more users and type of personality of the one or more users.

Further, the state of mind of the one or more users corresponds to mental condition of the one or more users. In an embodiment of the present disclosure, the mental condition of the one or more users corresponds to the one or more users in a normal state of mind or the one or more users in a stressed state of mind.

In an embodiment of the present disclosure, the generating module 204f generates the one or more treatment profiles for each of the one or more subgroups of one or more users.

In another embodiment of the present disclosure, the one or more treatment profiles are different for each of the one or more users based on the state of mind of the one or more users.

In yet another embodiment of the present disclosure, the one or more users with a high level of stress exhibit different kinds of reactions during the one or more treatments.

In yet another embodiment of the present disclosure, the generating module 204f generates the one or more treatment profiles corresponding to the pain level of the each of the one or more users. Further, the one or more treatment is effective at the particular pain level.

In yet another embodiment of the present disclosure, the one or more subgroups of one or more users is provided with one or more treatment options based on a list of tolerable side effects provided by the one or more users.

For example, a group X of one or more users Y is divided into a subgroup X1 of one or more users Y1, a subgroup X2 of one or more users Y2 and a subgroup X3 of one or more users Y3 corresponding to a pain response associated with the one or more users Y1, Y2 and Y3. The one or more users Y1 are further sub-categorized into two groups of one or more users Y1_A and Y1_B based on state of mind of the one or more users in Y1. The one or more users in the group Y1_A are in a normal state of mind and the one or more users in the group Y1_B are in a stressed state of mind. The one or more users in the group Y1_A are provided with treatments T1, T2, T3 and T4 and the one or more users in the group Y1_B are provided with treatments T5, T6 and T7. The treatment T1 and T2 works for the one or more users in the group Y1_A and the treatment T5 and T7 works for the one or more users in the group Y1_B. The generating module 204f generates a treatment profile corresponding to the one or more users Y1_A and the users Y1_B.

Moreover, the database 204i stores the one more treatment profiles of each of the one or more users and the set of pre-determined attributes of the one or more users. In an embodiment of the present disclosure, the one or more treatment profiles depict the one or more treatments provided to the one or more users.

In an embodiment of the present disclosure, the pain monitoring application 108 generates the treatment profile for the user 102. Further, the treatment profile includes the one or more treatments provided to the user 102.

The output engine 204g generates one or more side effect profiles for the one or more users based on the measured plurality of one or more bio-markers and response to the one or more treatments provided to the one or more users. Further, the one or more treatment profiles includes one or more side effects associated with the one or more treatments provided to each of the one or more users based on the set of pre-determined attributes associated with the one or more users. The one or more side effects occur during the one or more treatments provided to the one or more users. In addition, the one or more side effects include various physical and mental ailments.

Moreover, the physical and mental ailments include headache, swelling, weight gain, hair loss, drowsiness, anxiety, skin-disorders, neurological effect, cardiac effect, pulmonary effect, musculoskeletal effect, endocrinological effect, agitation, fatigue, muscle pain, joint pain, nausea, ulcers, sleeping problems, shortness of breath, memory problems, mood swings, loss of appetite, itching, rashes, internal bleeding, stomach pain, disturbance in blood flow, amnesia, loss of sight, hallucinations, asthma, dry mouth, convulsions, fast or irregular heartbeat, shivering, decrease in vision, indigestion, constipation, coughing, bleeding gums, sore throat, palpitations, anemia, depression and the like.

Furthermore, the database 204i stores the one or more side effect profiles of each of the one or more users.

The pain monitoring application 108 utilizes the stored one or more side effect profiles for providing a list of the one or more side effects associated with the one or more treatments to be provided to the user 102. In an embodiment of the present disclosure, the system 100 provides the list of the one or more side effects associated with the one or more treatment options to the user 102.

The user 102 provides a first list of undesirable side effects during the one or more treatments. Further, the user 102 provides the minimum gain required during the one or more treatments. The minimum gain is associated with an expected amount of pain reduction during the one or more treatments.

Furthermore, the pain monitoring application 108 generates a gain profile for the one or more users. Moreover, the gain profile depicts the amount of pain reduction experienced by the one or more users during the one or more treatments. In an embodiment of the present disclosure, the gain profile measures rate of the pain reduction for the one or more users. The database 204i stores the gain profile of the one or more users.

The recommendation engine 204h recommends an analogous treatment to the user 102 based on the one or more side effects profile and the one or more gain profile of the one or more users. The analogous treatment is provided corresponding to the set of pre-determined attributes associated with the one or more users. In an embodiment of the present disclosure, the analogous treatment is different for the one or more users in the normal state of mind and different for the one or more users in the stressed state of mind. In an embodiment of the present disclosure, the physician utilizes the side effect profile and the gain profile of the user 102 for recommending a treatment. Furthermore, the physician provides the treatment to the user 102 corresponding to the expected rate of pain reduction measured through the gain profile.

In an embodiment of the present disclosure, the analogous treatment is provided to the user 102 corresponding to the side effects associated with the analogous treatment. In another embodiment of the present disclosure, the recommendation of the analogous treatment is prohibited if the side effects of the analogous treatment do not coincide with the list of the tolerable side effects provided by the user 102. In yet another embodiment of the present disclosure, the side effects corresponding to the analogous treatment must be acceptable to the user 102.

In yet another embodiment of the present disclosure, the recommendation engine 204h recommends the analogous treatment to the user 102 based on medical history of the user 102. In another embodiment of the present disclosure, the medical history of the user 102 corresponds to pre-existing medical condition of the user 102, one or more previous treatments provided to the user 102 and one or more previous side effects experienced by the 102. In yet another embodiment of the present disclosure, the medical history of the user 102 depicts past response of the user 102 during the one or more treatments given to the 102.

In yet another embodiment of the present disclosure, the recommendation of the analogous treatment to a user (say user 102) with some medical history is different than the treatment recommended to the other one or more users having no medical history. In yet another embodiment of the present disclosure, the treatment recommendation for an existing medical condition is different in case of the user (say user 102) having the pre-existing medical condition.

In yet another embodiment of the present disclosure, the one or more users in an enormously high stressed state of mind are recommended different variations of the one or more treatments.

For example, a user X was previously suffering from a spinal injury and had undergone the one or more treatments and experienced the one or more side effects. The user X is currently suffering from a head injury and consults a medical practitioner for any treatment. Similarly a user Y was suffering from a neck injury and is currently also suffering from a head injury. The recommendation engine 204h recommends different treatment to the user X and a different treatment to the user Y based on their medical history. Furthermore, the user Y is in a highly stressed state of mind. The recommendation engine 204h recommends a different treatment from the one recommended if the user Y was in a normal state of mind.

In another embodiment of the present disclosure, the recommendation engine 204i recommends one or more treatment to the one or more users.

It may be noted that the database 204i stores the gain profile of the user 102, however those skilled in the art would appreciate that the database 204i stores more than one gain profile of more than one user.

In an embodiment of the present disclosure, the pain profile for the user 102 can be generated using any combination of the plurality of bio-sensors 104.

In yet another embodiment of the present disclosure, the intensity of pain experienced by the user 102 is characterized by biological factors (for example, sex, genetics and the like), psychological factors (for example, mood, attention and the like), experimental factors and the like.

Going further, the communication device 202 includes any suitable type of portable electronic device. Examples of the communication device 202 include but may not be limited to a personal e-mail device (e.g., a Blackberry™ made available by Research in Motion of Waterloo, Ontario), a personal data assistant (“PDA”), a cellular telephone, a Smartphone, a handheld gaming device, a digital camera, the laptop computer, and a tablet computer. In another embodiment of the present disclosure, the communication device 202 can be a desktop computer.

From the perspective of this disclosure, the control circuitry module 206 includes any processing circuitry or processor operative to control the operations and performance of the communication device 202. For example, the control circuitry module 206 may be used to run operating system applications, firmware applications, media playback applications, media editing applications, or any other application. In an embodiment, the control circuitry module 206 drives a display and process inputs received from a user interface.

From the perspective of this disclosure, the storage module 208 includes one or more storage mediums including a hard-drive, solid state drive, flash memory, permanent memory such as ROM, any other suitable type of storage component, or any combination thereof. The storage module 208 may store, for example, media data (e.g., music and video files), application data (e.g., for implementing functions on the communication device 202).

From the perspective of this disclosure, the input/output circuitry module 210 may be operative to convert (and encode/decode, if necessary) analog signals and other signals into digital data. In an embodiment, the input/output circuitry module 210 may also convert the digital data into any other type of signal and vice-versa. For example, the input/output circuitry module 210 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 206, the storage module 208 or any other component of the communication device 202.

It may be noted that the input/output circuitry module 210 is illustrated in FIG. 2 as a single component of the communication device 202; however those skilled in the art would appreciate that several instances of the input/output circuitry module 210 may be included in the communication device 202.

The communication device 202 may include any suitable interface or component for allowing the user 102 to provide inputs to the input/output circuitry module 210. The communication device 202 may include any suitable input mechanism. Examples of the input mechanism include but may not be limited to a button, keypad, dial, a click wheel, and a touch screen. In an embodiment, the communication device 202 may include a capacitive sensing mechanism, or a multi-touch capacitive sensing mechanism.

In an embodiment, the communication device 202 may include specialized output circuitry associated with output devices such as, for example, one or more audio outputs. The audio output may include one or more speakers built into the communication device 202, or an audio component that may be remotely coupled to the communication device 202.

The one or more speakers can be mono speakers, stereo speakers, or a combination of both. The audio component can be a headset, headphones or ear buds that may be coupled to the communication device 202 with a wire or wirelessly.

In an embodiment, the input/output circuitry module 210 may include display circuitry for providing a display visible to the user 102. For example, the display circuitry may include a screen (e.g., an LCD screen) that is incorporated in the communication device 202.

The display circuitry may include a movable display or a projecting system for providing a display of content on a surface remote from the communication device 202 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 206. Alternatively, the display circuitry may be operative to provide instructions to a remote display.

In addition, the communication device 202 includes the communication circuitry module 212. The communication circuitry module 212 may include any suitable communication circuitry operative to connect to a communication network and to transmit communications (e.g., voice or data) from the communication device 202 to other devices within the communications network. The communication circuitry module 212 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quad-band.

In an embodiment, the communication circuitry module 212 may be operative to create a communications network using any suitable communications protocol. For example, the communication circuitry module 212 may create a short-range communication network using a short-range communications protocol to connect to other devices. For example, the communication circuitry module 212 may be operative to create a local communication network using the Bluetooth® protocol to couple the communication device 202 with a Bluetooth® headset.

It may be noted that the computing device is shown to have only one communication operation; however, those skilled in the art would appreciate that the communication device 202 may include one more instances of the communication circuitry module 212 for simultaneously performing several communication operations using different communication networks. For example, the communication device 202 may include a first instance of the communication circuitry module 212 for communicating over a cellular network, and a second instance of the communication circuitry module 212 for communicating over Wi-Fi or using Bluetooth®.

In an embodiment, the same instance of the communication circuitry module 212 may be operative to provide for communications over several communication networks. In an embodiment, the communication device 202 may be coupled a host device for data transfers, synching the communication device 202, software or firmware updates, providing performance information to a remote source (e.g., providing riding characteristics to a remote server) or performing any other suitable operation that may require the communication device 202 to be coupled to a host device. Several computing devices may be coupled to a single host device using the host device as a server. Alternatively or additionally, the communication device 202 may be coupled to the several host devices (e.g., for each of the plurality of the host devices to serve as a backup for data stored in the communication device 202).

It may be noted that in FIG. 2, various modules of the pain monitoring application 108 are shown that illustrates the working of the pain monitoring application 108; however those skilled in the art would appreciate that the pain monitoring application 108 may have more number of modules that could illustrate overall functioning of the pain monitoring application 108.

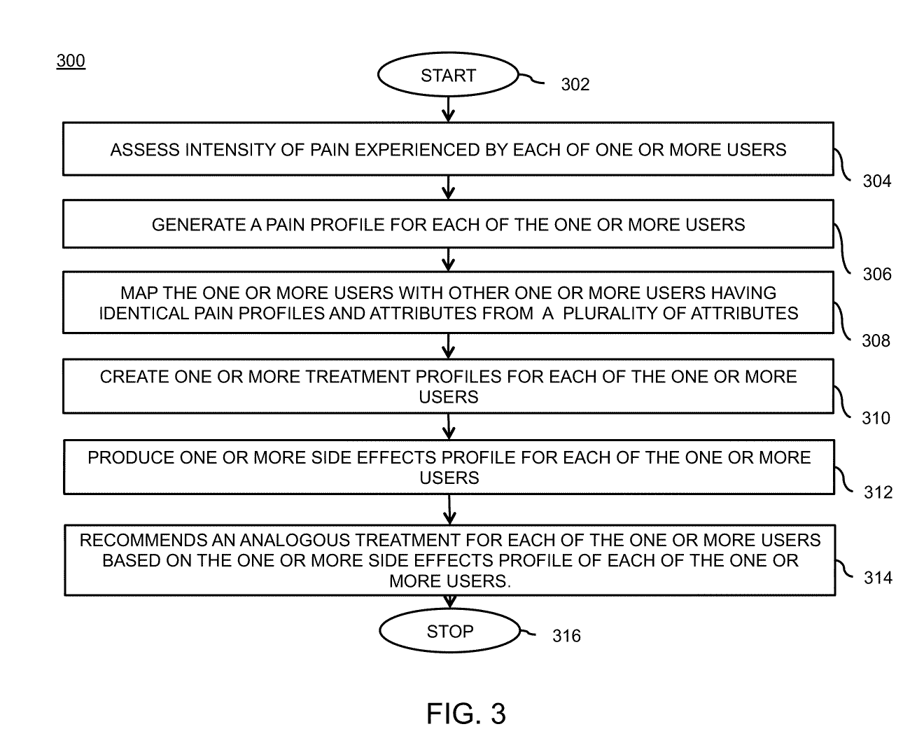

FIG. 3 illustrates a flowchart 300 for recommending the analogous treatment for the one or more users, in accordance with various embodiments of the present disclosure. The flow chart 300 initiates at a step 302. Following the step 302, at a step 304, the diagnostic engine 204c assesses the intensity of pain experienced by each of the one or more users. At a step 306, the presentation module 204d generates the pain profile for the one or more users. At a step 308, the mapping module 204e maps the one or more users with other one or more users having the identical pain profiles and attributes from the plurality of attributes. At a step 310, the generating module 204f creates the one or more treatment profiles for the one or more users. At step 312, the output engine 204g produces the one or more side effects profile for the one or more users. At step 314, the recommendation engine 204h recommends the analogous treatment for each of the one or more users based on the one or more side effects profile of each of the one or more users. The flowchart 300 terminates at a step 316.

It may be noted that the flowchart 300 is explained to have above stated process steps; however those skilled in the art would appreciate that the flowchart 300 may have more/less number of process steps which may enable all the above stated embodiments of the present disclosure.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method comprising:
assessing, with a processor, an intensity of pain experienced by each of one or more users, wherein the intensity of pain being assessed on a pre-determined set of pain monitoring scales based on an age of the one or more users;
generating, with the processor, a pain profile for each of the one or more users, wherein the generated pain profile shows the intensity of pain experienced by each of the one or more users at various points in body aiding in better medical treatment of each of the one or more users;
mapping, with the processor, the one or more users with other one or more users having identical pain profiles and attributes from a plurality of attributes;
creating, with the processor, one or more treatment profiles for each of the one or more users, the creation of the one or more treatment profiles comprising:
categorizing the one or more users into groups of one or more users corresponding to pain response of each of the one or more users; and
sub-categorizing each of the categorized groups of one or more users into one or more subgroups of one or more users based on a set of pre-determined attributes associated with the one or more users, wherein the one or more treatment profiles being created for each of the one or more subgroups of the one or more users;
producing, with the processor, one or more side effects profile for each of the one or more users, wherein the one or more side effects profile comprises one or more side effects corresponding to one or more treatments provided to each of the one or more users and the one or more treatments being provided based on the set of pre-determined attributes associated with the one or more users; and
recommending, with the processor, an analogous treatment for each of the one or more users based on the one or more side effects profile of each of the one or more users, wherein the analogous treatment being provided corresponding to the set of pre-determined attributes associated with the one or more users.

2. The computer-implemented method as recited in claim 1, further comprising generating, with the processor, one or more gain profiles for each of the one or more users.

3. The computer-implemented method as recited in claim 2, wherein the one or more gain profiles depict rate of reduction of pain corresponding to each of the one or more users.

4. The computer-implemented method as recited in claim 1, wherein the set of pre-determined attributes comprises at least one of state of mind of the one or more users and type of personality of the one or more users.

5. The computer-implemented method as recited in claim 1, wherein the recommendation of the analogous treatment being further based on medical history of the one or more users, wherein the medical history of the one or more users corresponds to pre-existing medical condition of the one or more users, one or more previous treatments provided to the one or more users and one or more previous side effects experienced by the one or more users.

6. The computer-implemented method as recited in claim 1, wherein the one or more subgroups of the one or more users being provided with one or more treatment options based on a list of tolerable side effects provided by the one or more users.

7. The computer-implemented method as recited in claim 1, further comprising tabulating, with the processor, data of the pain response of each of the one or more users, wherein the tabulated data being used for medical treatment of each of the one or more users.

8. The computer-implemented method as recited in claim 1, wherein the one or more side effects corresponding to the one or more treatments comprises various physical or mental ailments, wherein the physical or mental ailments comprises at least one of headache, swelling, weight gain, hair loss, drowsiness, anxiety, skin-disorders, neurological effect, cardiac effect, pulmonary effect, musculoskeletal effect, endocrinological effect, agitation, fatigue, muscle pain, joint pain, nausea, ulcers, sleeping problems, shortness of breath, memory problems, mood swings, loss of appetite, itching, rashes, internal bleeding, stomach pain, disturbance in blood flow, amnesia, loss of sight, hallucinations, asthma, dry mouth, convulsions, fast or irregular heartbeat, shivering, decrease in vision, indigestion, constipation, coughing, bleeding gums, sore throat, palpitations, anemia and depression.

9. The computer-implemented method as recited in claim 1, wherein the computer-implemented method being further configured to store, with the processor, the generated pain profile of each of the one or more users, the one or more treatment profiles of each of the one or more users, the side effects profile of each of the one or more users, the one or more gain profiles of one or more users and the tabulated data of the pain response of each of the one or more users.

10. A computer program product comprising a non-transitory computer readable medium storing a computer readable program, wherein the computer readable program when executed on a computer causes the computer to perform steps comprising:
assessing an intensity of pain experienced by each of one or more users, wherein the intensity of pain being assessed on a pre-determined set of pain monitoring scales based on age of the one or more users;
generating a pain profile for each of the one or more users, wherein the generated pain profile shows the intensity of pain experienced by each of the one or more users at various points in body aiding in better medical treatment of each of the one or more users;
mapping the one or more users with other one or more users having identical pain profiles and attributes from a plurality of attributes;
creating one or more treatment profiles for each of the one or more users, the creation of the one or more treatment profiles comprising:
categorizing the one or more users into groups of one or more users corresponding to pain response of each of the one or more users; and
sub-categorizing each of the categorized groups of one or more users into one or more subgroups of one or more users based on a set of pre-determined attributes associated with the one or more users, wherein the one or more treatment profiles being created for each of the one or more subgroups of the one or more users;
producing one or more side effects profile for each of the one or more users, wherein the one or more side effects profile comprises one or more side effects corresponding to one or more treatments provided to each of the one or more users and the one or more treatments being provided based on the set of pre-determined attributes associated with the one or more users; and
recommending an analogous treatment for each of the one or more users based on the one or more side effects profile of each of the one or more users, wherein the analogous treatment being provided corresponding to the set of pre-determined attributes associated with the one or more users.

11. The computer program product as recited in claim 10, wherein the computer readable program when executed on the computer causes the computer to perform a further step of generating one or more gain profiles for each of the one or more users.

12. A system comprising:
a communication device, wherein the communication device further comprises a pain monitoring application to monitor intensity of pain experienced by each of one or more users, wherein the pain monitoring application comprises:
an input/output module in a processor, the input/output module being configured to receive a plurality of one or more bio-markers associated with each of the one or more users;
a display module in the processor, the display module being configured to display the plurality of one or more bio-markers associated with the one or more users;
a diagnostic engine in the processor, the diagnostic engine being configured to assess an intensity of pain experienced by each of one or more users, wherein the intensity of pain being assessed on a pre-determined set of pain monitoring scales based on age of the one or more users;
a presentation module in the processor, the presentation module being configured to generate a pain profile for each of the one or more users, wherein the generated pain profile shows the intensity of pain experienced by the one or more users at various points in body aiding in better medical treatment of the one or more users;
a mapping module in the processor, the mapping module being configured to map and index the one or more users with other one or more users having identical pain profiles and attributes from a plurality of attributes;
a generating module in the processor, the generating module being configured to create one or more treatment profiles for each of the one or more users, the creation of the one or more treatment profiles comprising:
categorizing the one or more users into groups of one or more users corresponding to pain response of each of the one or more users; and
sub-categorizing each of the categorized groups of the one or more users into one or more subgroups of one or more users based on a set of pre-determined attributes associated with the one or more users, wherein the one or more treatment profiles being created for each of the one or more subgroups of the one or more users;
an output engine in the processor, the output engine being configured for producing one or more side effects profile for each of the one or more users, wherein the one or more side effects profile comprises one or more side effects corresponding to one or more treatments provided to each of the one or more users and the one or more treatments being provided based on the set of pre-determined attributes associated with the one or more users;
a recommendation engine in the processor, the recommendation engine being configured for recommending an analogous treatment for each of the one or more users based on the one or more side effects profile of each of the one or more users, wherein the analogous treatment being provided corresponding to the set of pre-determined attributes associated with the one or more users; and
a database in the processor, the database being configured to store the generated pain profile of each of the one or more users, the one or more treatment profiles of each of the one or more users, the side effects profile of each of the one or more users and the set of pre-determined attributes of the one or more users.

13. The system as recited in claim 12, further comprising an application server being configured to run the pain monitoring application.

14. The system as recited in claim 12, wherein the diagnostic engine in the processor being further configured to tabulate data of the pain response of each of the one or more users, wherein the tabulated data being used for medical treatment of each of the one or more users.

15. The system as recited in claim 12, further comprising generating one or more gain profiles for each of the one or more users, wherein the one or more gain profiles of each of the one or more users being stored in the database.

16. The system as recited in claim 15, wherein the one or more gain profiles depict rate of reduction of pain corresponding to each of the one or more users.

17. The system as recited in claim 12, wherein the set of pre-determined attributes comprises at least one of state of mind of the one or more users and type of personality of the one or more users.

18. The system as recited in claim 12, wherein the recommendation engine in the processor recommends the analogous treatment further based on medical history of the one or more users, wherein the medical history of the one or more users corresponds to pre-existing medical condition of the one or more users, one or more previous treatments provided to the one or more users and one or more previous side effects experienced by the one or more users.

19. The system as recited in claim 12, wherein the one or more subgroups of the one or more users being provided with one or more treatment options based on a list of tolerable side effects provided by the one or more users.

20. The system as recited in claim 12, wherein the one or more side effects corresponding to the one or more treatments comprises various physical or mental ailments, wherein the physical or mental ailments comprises at least one of headache, swelling, weight gain, hair loss, drowsiness, anxiety, skin-disorders, neurological effect, cardiac effect, pulmonary effect, musculoskeletal effect, endocrinological effect, agitation, fatigue, muscle pain, joint pain, nausea, ulcers, sleeping problems, shortness of breath, memory problems, mood swings, loss of appetite, itching, rashes, internal bleeding, stomach pain, disturbance in blood flow, amnesia, loss of sight, hallucinations, asthma, dry mouth, convulsions, fast or irregular heartbeat, shivering, decrease in vision, indigestion, constipation, coughing, bleeding gums, sore throat, palpitations, anemia and depression.
